(19) United States
(12) Patent Application Publication
(10) Pub. No.: US 2023/0421599 A1
(43) Pub. Date: Dec. 28, 2023

(54) ATTACK STATUS EVALUATION APPARATUS, ATTACK STATUS EVALUATION METHOD, AND COMPUTER READABLE MEDIUM

(71) Applicant: Mitsubishi Electric Corporation, Tokyo (JP)

(72) Inventors: Shun KATO, Tokyo (JP); Kiyoto KAWAUCHI, Tokyo (JP); Keisuke KITO, Tokyo (JP)

(73) Assignee: Mitsubishi Electric Corporation, Tokyo (JP)

(21) Appl. No.: 18/244,388

(22) Filed: Sep. 11, 2023

Related U.S. Application Data
(63) Continuation of application No. PCT/JP2021/017427, filed on May 7, 2021.

(51) Int. Cl. H04L 9/40; G06F 21/57

(52) U.S. Cl. CPC H04L 63/1433; G06F 21/577; G06F 2221/034

(57) ABSTRACT

An attack status evaluation apparatus (100) that emulates a cyberattack that steals information includes a degree of goal achievement calculation unit (105) and an attack route change determination unit (106). The degree of goal achievement calculation unit (105) calculates a degree of goal achievement that indicates a degree to which a goal is achieved in the cyberattack based on information that the attack status evaluation apparatus stole. The attack route change determination unit (106) determines whether or not to change an attack route of the cyberattack according to the degree of goal achievement.

### CROSS REFERENCE TO RELATED APPLICATION

This application is a Continuation of PCT International Application No. PCT/JP2021/017427, filed on May 7, 2021, which is hereby expressly incorporated by reference into the present application.

### TECHNICAL FIELD

The present disclosure relates to an attack status evaluation apparatus, an attack status evaluation method, and an attack status evaluation program.

### BACKGROUND ART

A vulnerability, a weakness in security, is becoming an issue socially, and in recent years, execution of a vulnerability check that investigates existence or non-existence of a vulnerability, severity of the vulnerability, and the like is in demand before a release of a system, before a shipment of a product, or the like. In a penetration test that is known as a technique of the vulnerability check, by performing a cyberattack in a simulated manner on a target system, existence or non-existence of a vulnerability, severity of when the vulnerability is exploited, and further, whether or not the cyberattack can be detected are investigated. A conventional penetration test had been done manually by a penetration tester with expertise. Since shortage in security personnel continues, however, development of technology to automatically execute the penetration test is in progress so that a person without expertise can perform the penetration test.

Patent Literature 1 discloses technology to execute a security assessment based on a vulnerability that a system has. In the present technology, the security assessment is performed by determining whether or not the system has a vulnerability in a point where the system can have a vulnerability, searching for an attack route based on the point that has the vulnerability, and verifying scale of damage from the cyberattack according to a degree of importance of asset information that can be reached on the attack route that is discovered by searching.

### CITATION LIST

### Patent Literature

Patent Literature 1: JP 2008-257577 A

### SUMMARY OF INVENTION

### Technical Problem

Although in an actual cyberattack, an attack route is searched for utilizing not only vulnerability information that indicates a vulnerability but also asset information, there is an issue in the technology of Patent Literature 1 where the vulnerability information is utilized but asset information is not utilized when searching for an attack route.

The present disclosure aims to search for an attack route utilizing not only vulnerability information but also asset information.

### Solution to Problem

An attack status evaluation apparatus according to the present disclosure is an attack status evaluation apparatus that emulates a cyberattack that steals information. The attack status evaluation apparatus includes:
a degree of goal achievement calculation unit to calculate a degree of goal achievement that indicates a degree to which a goal is achieved in the cyberattack based on information that the attack status evaluation apparatus stole; and
an attack route change determination unit to determine whether or not to change an attack route of the cyberattack according to the degree of goal achievement.

### Advantageous Effects of Invention

According to the present disclosure, an attack route change determination unit determines whether or not to change an attack route of a cyberattack according to a degree of goal achievement. Since the degree of goal achievement indicates a degree to which a goal is achieved in the cyberattack, the degree of goal achievement is typically set based on asset information. Consequently, according to the present disclosure, an attack route can be searched for utilizing not only vulnerability information but also asset information.

### BRIEF DESCRIPTION OF DRAWINGS

FIG. 1 is a diagram illustrating an example of a configuration of an attack status evaluation apparatus 100 according to Embodiment 1.

FIG. 2 is a diagram describing an attack goal DB (Database) 107 according to Embodiment 1.

FIG. 3 is a diagram describing a vulnerability score DB 110 according to Embodiment 1.

FIG. 4 is a diagram illustrating an example of a hardware configuration of the attack status evaluation apparatus 100 according to Embodiment 1.

FIG. 5 is a diagram illustrating an example of a hardware configuration of the attack status evaluation apparatus 100 according to Embodiment 1.

FIG. 6 is a flowchart illustrating operation of the attack status evaluation apparatus 100 according to Embodiment 1.

FIG. 7 is a diagram describing an attack route change.

FIG. 8 is a diagram illustrating an example of a hardware configuration of a computer 10 according to a variation of Embodiment 1.

### DESCRIPTION OF EMBODIMENTS

In the description of the embodiment and in the drawings, the same reference signs are added to the same elements and corresponding elements. Descriptions of elements having the same reference signs added will be suitably omitted or simplified. Arrows in the diagrams mainly indicate flows of data or flows of processes. “Unit” may be suitably replaced with “circuit”, “step”, “procedure”. “process”, or “circuitry”.

### Embodiment 1

The present embodiment will be described in detail below by referring to the drawings.

***Description of Configuration***

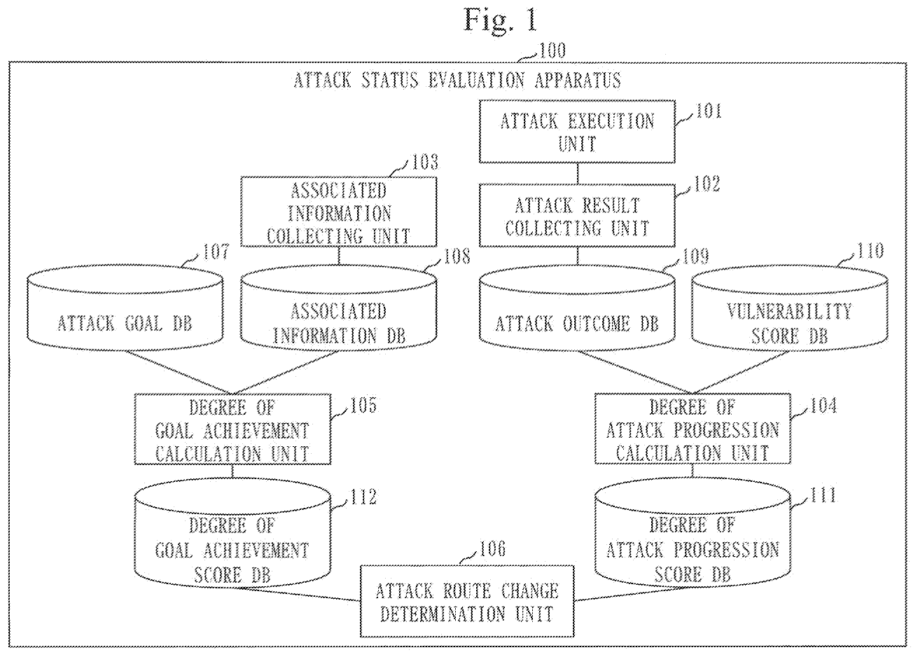

FIG. 1 illustrates an example of a configuration of an attack status evaluation apparatus 100 according to the present embodiment. The attack status evaluation apparatus 100 is also called a cyberattack status evaluation apparatus. The attack status evaluation apparatus 100 emulates a cyberattack that steals information.

The attack status evaluation apparatus 100 is configured of an attack execution unit 101, an attack result collecting unit 102, an associated information collecting unit 103, a degree of attack progression calculation unit 104, a degree of goal achievement calculation unit 105, an attack route change determination unit 106, an attack goal DB 107, an associated information DB 108, an attack outcome DB 109, a vulnerability score DB 110, a degree of attack progression score DB 111, and a degree of goal achievement score DB 112. The cyberattack typically means a simulated or an emulated cyberattack. There is a case where the cyberattack is simply written as an attack. The attack execution unit 101 is also called a cyberattack execution unit. The attack result collecting unit 102 is also called a cyberattack result collecting unit. The associated information collecting unit 103 is also called an attack goal associated information collecting unit. The associated information DB 108 is also called an attack goal associated information DB.

The attack execution unit 101 selects a means of the cyberattack from a surrounding situation that has been obtained to date, and executes the cyberattack on an attack target by executing the means that is selected. The surrounding situation, as a specific example, is a vulnerability that is discovered or a type of OS (Operating System) of the attack target.

The attack result collecting unit 102 collects information that is obtained when the cyberattack is executed. The information, as a specific example, is vulnerability information that is discovered, information on an open port that is discovered, or authentication information that the attack execution unit 101 stole. The information that the attack result collecting unit 102 collected is stored in the attack outcome DB 109.

The associated information collecting unit 103 collects information associated with a goal of the attack that is defined beforehand. As a specific example, when the goal of the attack is “taking over confidential information”, the associated information collecting unit 103 collects information on a file, an email, and the like in a terminal into where the attack execution unit 101 intruded. The information that the associated information collecting unit 103 collected is stored in the associated information DB 108. Here, the information that the associated information collecting unit 103 steals from the terminal into where the attack execution unit 101 intruded and the information on the file, the email, and the like is asset information.

The degree of attack progression calculation unit 104 calculates a degree of attack progression that indicates a progression situation of the cyberattack with information that the attack outcome DB 109 indicates and information that the vulnerability score DB 110 indicates as input. The degree of attack progression calculation unit 104 calculates the degree of attack progression based on the vulnerability information that indicates a vulnerability in the terminal and the like that are targets of the cyberattack. The degree of attack progression calculation unit 104 calculates the degree of attack progression based on attack outcome information. The degree of attack progression is presented to a penetration tester and is utilized for the penetration tester to confirm the degree of progression of the attack. The attack outcome information is information that the attack status evaluation apparatus 100 stole and is information equivalent to an outcome of the cyberattack

A calculation method of the degree of attack progression will be shown below. First, the degree of attack progression calculation unit 104 extracts elements of the attack by referring to ATT&CK (Adversarial Tactics, Techniques, and Common Knowledge), a cyber kill chain, or the like, and builds a calculation formula for the degree of attack progression by combining the elements of the attack that are extracted. Here, a specific example of the calculation formula for the degree of attack progression in a case where the goal of the attack is “taking over confidential information” will be shown in [Mathematical Formula 1].

(Degree of attack progression)=max(con_1, . . . ,con_n,other_1, . . . ,other_n)*((1)+(2)+(3)+(4)) [Mathematical Formula 1]
(1)=(p_1+v_1+ser_1)+ . . . +(p_(n+m)+v_(n+m)+ser_(n+m))+ip+os
(2)=cvss_1+ . . . +cvss_at
(3)=f+(l_1*max(con_1, other 1))+ . . . +(l_n*max(con_n, other_n))
(4)=(au_1+ . . . +au_x)−(dau_1+ . . . +dau_y)

Since the goal this time is “taking over confidential information”, the attack execution unit 101 is required to take the file externally of the attack target. Each of con_1 to con_n is a binary variable that represents a connection to a server that gives a command and the like to malware called a C&C (Command and Control) server and that an attacker prepared. Each of other_1 to other_n is a binary variable that represents an external connection other than the connection to the C&C server. A value of these binary variables is 0 when not connected to an external server and the like, and 1 when connected to an external server and the like. Note that n represents the number of terminals into where the attack execution unit 101 intruded, and in a case where an external connection is disconnected in all of the terminals into where the attack execution unit 101 intruded once, a score value of the degree of attack progression becomes 0. In a case where the score value of the degree of attack progression becomes 0, the attack execution unit 101 may end the attack.

Each of (1) to (4) corresponds to the attack outcome information, and represents an outcome of the attack when the attack execution unit 101 executed an attack means. Here, each of p_1 to p_(n+m) represents the number of open ports that are discovered in each terminal. Each of v_1 to v_(n+m) represents the number of vulnerabilities that are discovered in each terminal. Each of ser_1 to ser_(n+m) represents the number of services that are running on each terminal. Note that m represents the number of next attack target candidates. Note that ip represents the number of terminals of which an IP address became known. Note that os represents the number of terminals of which a version of an OS became known. Each of cvss_1 to cvss_at represents a score of a vulnerability on which the attack was successful. Note that at represents the number of successes of the attack. Note that f represents the number of files that the attack execution unit 101 stole. Each of l_1 to l_n represents a level of a privilege of each terminal. Each of au_1 to au_x represents a value that corresponds to the authentication information that the attack execution unit 101 stole, and a value with a gradient being applied depending on whether the authentication information is temporally or permanent. Note that x represents the number of pieces of authentication information that the attack execution unit 101 stole. Each of dau_1 to dau_y represents a value that corresponds to the authentication information that the attack execution unit 101 stole, and a value with a gradient being applied to authentication information that can no longer be used among the authentication information that the attack execution unit 101 stole. Note that y represents the number of pieces of authentication information that can no longer be used among the authentication information that the attack execution unit 101 stole. The degree of attack progression calculation unit 104 recalculates each value from cvss_1 to cvss_at using CVSS (Common Vulnerability Scoring System) environmental score according to the goal of the attack.

The degree of goal achievement calculation unit 105 calculates a degree of goal achievement that indicates a degree to which a goal is achieved in the cyberattack based on associated information with information that the attack goal DB 107 indicates and information that the associated information DB 108 indicates as input. The associated information is the information that the attack status evaluation apparatus stole and is information associated with achieving the goal. The associated information may include information that indicates an access right.

A calculation method of the degree of goal achievement will be shown below. The degree of goal achievement is calculated, based on the goal that is defined beforehand, according to information associated with a goal that has been obtained to date, a privilege, authentication, or the like relating to the goal that has been obtained to date.

A goal of the attack stored in the attack goal DB 107 is defined beforehand on a text basis in a way that whether or not the information that is obtained is the information associated with an attack goal can be verified. As a specific example, in a case where the goal of the attack is “taking over confidential information”, first, the penetration tester extracts a keyword associated with the confidential information that is an aim and registers the keyword that is extracted in a word list. Next, the penetration tester stores the word list as the goal of the attack in the attack goal DB 107.

A specific example of a calculation formula for the degree of goal achievement in a case where the goal of the attack is “taking over confidential information” will be shown in [Mathematical Formula 2].

(Degree of goal achievement)=key_f+α*key_m+fs+lf+α*ms [Mathematical Formula 2]

Here, key_f represents the number of files that the attack execution unit 101 stole and in which the keyword appeared. Note that key_m represents the number of emails that the attack execution unit 101 stole and in which the keyword appeared. Each of key_f and key_m is information that indicates a part of the asset information or an amount of the asset information that the attack execution unit 101 stole. Note that fs represents a type of access right of a file server that the attack execution unit 101 stole. Note that lf represents a type of access right of a local file that the attack execution unit 101 stole. Note that ms represents a type of access right of a mail server that the attack execution unit 101 stole. Note that α is a weighted variable that takes a value more than or equal to 0 and less than or equal to 1. A reason that an item relating to the email is multiplied by weighted variable a is because discovering a file associated with the goal is considered to bring the attack status evaluation apparatus 100 closer to the goal than discovering an email associated with the goal.

The attack route change determination unit 106 determines whether or not to change an attack route of the cyberattack according to the degree of goal achievement, and typically determines to change the attack route in a way to increase the degree of goal achievement. The attack route change determination unit 106 may determine whether or not to change the attack route of the cyberattack according to the degree of attack progression.

The attack goal DB 107 stores the goal of the attack that is defined beforehand.

The associated information DB 108 stores the information that is collected associated with the goal of the attack.

The attack outcome DB 109 stores the attack outcome information that is the information obtained by the cyberattack.

The vulnerability score DB 110 stores a score value of a degree of risk of a vulnerability.

The degree of attack progression score DB 111 stores the score value of the degree of attack progression.

The degree of goal achievement score DB 112 stores a score value of the degree of goal achievement.

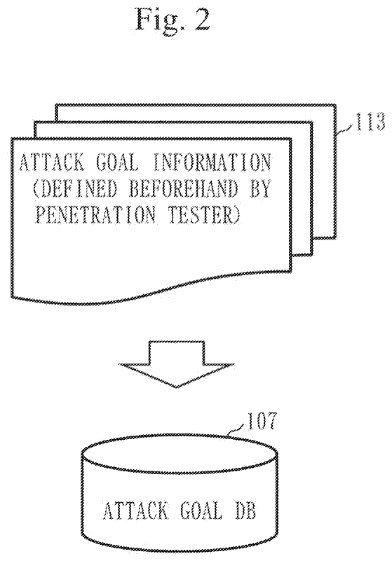

FIG. 2 illustrates storing of attack goal information 113 in the attack goal DB 107.

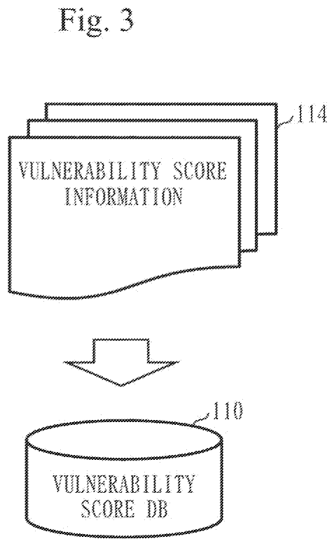

FIG. 3 illustrates storing of vulnerability score information 114 in the vulnerability score DB 110. The vulnerability score information 114 is also a score value of a degree of threat of each vulnerability.

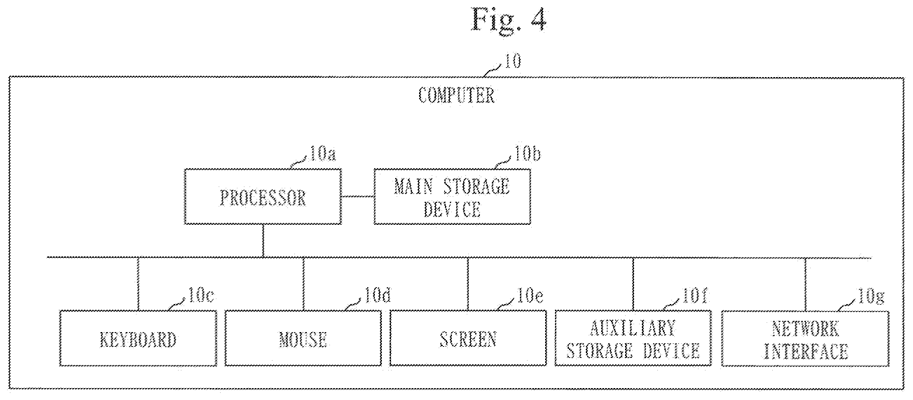

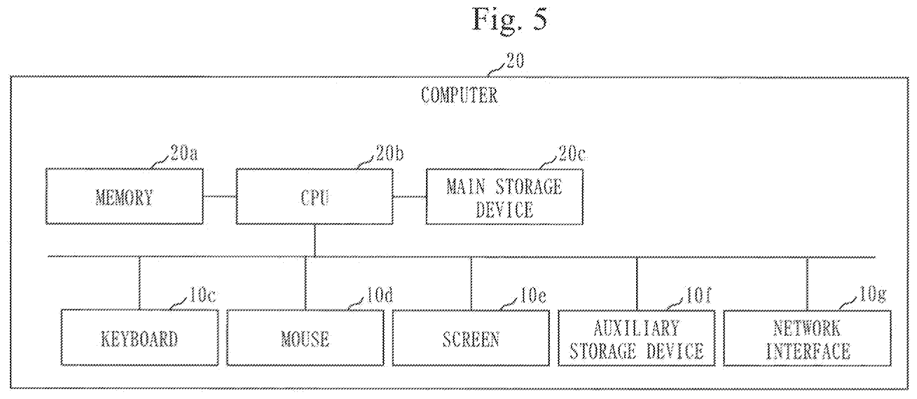

Each of FIG. 4 and FIG. 5 illustrates an example of a hardware configuration of the attack status evaluation apparatus 100.

A computer 10 illustrated in FIG. 4 is configured of a processor 10a that is a calculation means, a main storage device 10b, a keyboard 10c and a mouse 10d that use USB (Universal Serial Bus) connections and the like, a screen 10e that performs display output to a user, an auxiliary storage device 10f, and a network interface 10g used for performing communication with the outside. The computer 10 may consist of a plurality of computers.

The processor 10a is an IC (Integrated Circuit) that performs a calculation process, and controls hardware that the computer includes. The computer 10 may include a plurality of processors that replace the processor 10a. The plurality of processors share roles of the processor 10a.

The main storage device 10b is typically a volatile storage device, and as a specific example, is a RAM (Random Access Memory).

The screen 10e, as a specific example, is an LCD (Liquid Crystal Display).

The auxiliary storage device 10f is typically a non-volatile storage device.

The auxiliary storage device 10f, as a specific example, is a ROM (Read Only Memory), an HDD (Hard Disk Drive), or a flash memory. Data stored in the auxiliary storage device 10f is loaded into the main storage device 10b as necessary. The auxiliary storage device 10f has stored an attack status evaluation program. The attack status evaluation program is a program that causes a computer to enable functions of each unit that the attack status evaluation apparatus 100 includes. The attack status evaluation program is loaded into the main storage device 10b, and executed by the processor 10a. The functions of each unit that the attack status evaluation apparatus 100 includes are enabled by software. The attack status evaluation program may be recorded in a computer-readable non-volatile recording medium. The non-volatile recording medium, as a specific example, is an optical disc or a flash memory. The attack status evaluation program may be provided as a program product.

The network interface 10g, as a specific example, is a communication chip or an NIC (Network Interface Card).

In a case where the attack status evaluation apparatus 100 is enabled by the hardware configuration illustrated in FIG. 4, in the processor 10a that is program controlled, each of the attack execution unit 101, the attack result collecting unit 102, the associated information collecting unit 103, the degree of attack progression calculation unit 104, the degree of goal achievement calculation unit 105, and the attack route change determination unit 106 is enabled. In the main storage device 10b and the auxiliary storage device 10f, each of the attack goal DB 107, the associated information DB 108, the attack outcome DB 109, the vulnerability score DB 110, the degree of attack progression score DB 111, and the degree of goal achievement score DB 112 is enabled.

A computer 20 illustrated in FIG. 5 is configured of a memory 20a with a built-in program, a CPU (Central Processing Unit) 20b that is a calculation means, a main storage device 20c, the keyboard 10c, the mouse 10d, the screen 10e, the auxiliary storage device 10f, and the network interface 10g. The computer 20 is basically a same as the computer 10.

In a case where the attack status evaluation apparatus 100 is enabled by the hardware configuration illustrated in FIG. 5, in the memory 20a and the CPU 20b, each of the attack execution unit 101, the attack result collecting unit 102, the associated information collecting unit 103, the degree of attack progression calculation unit 104, the degree of goal achievement calculation unit 105, and the attack route change determination unit 106 is enabled. In the main storage device 20c and an auxiliary storage device 20g, each of the attack goal DB 107, the associated information DB 108, the attack outcome DB 109, the vulnerability score DB 110, the degree of attack progression score DB 111, and the degree of goal achievement score DB 112 is enabled.

***Description of Operation***

An operation procedure of the attack status evaluation apparatus 100 is equivalent to an attack status evaluation method. A program that enables operation of the attack status evaluation apparatus 100 is equivalent to the attack status evaluation program.

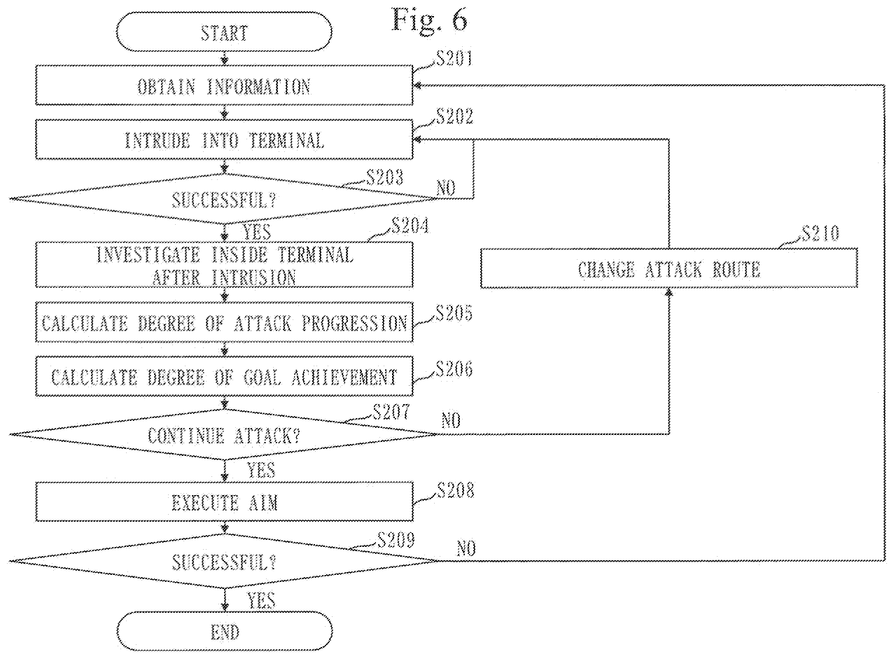

FIG. 6 is a flowchart illustrating one example of an overall picture of the cyberattack by the attack status evaluation apparatus 100. The operation of the attack status evaluation apparatus 100 will be described using the present diagram.

(Step S201)

The attack execution unit 101 investigates a surrounding situation of a terminal into where the attack execution unit 101 is currently intruding or of a network segment. Investigation of the surrounding situation is performed using a tool such as Nmap (Network Mapper), Nessus (registered trademark), or the like as a specific example.

(Step S202)

The attack execution unit 101 executes an intrusion into a terminal different from the terminal into where the attack execution unit 101 is currently intruding.

(Step S203)

The attack execution unit 101 determines whether or not the intrusion in step S202 was successful. In a case where the intrusion was successful, the attack status evaluation apparatus 100 proceeds to step S204. In other cases, the attack status evaluation apparatus 100 returns to step S202.

When the attack execution unit 101 executes the intrusion into a different terminal, the attack execution unit 101 attempts an intrusion into a terminal into where the attack execution unit 101 may be able to intrude until the intrusion is successful. At this time, the attack execution unit 101 may change the terminal into where the intrusion is attempted to a different terminal within the network segment into where the attack execution unit 101 is currently intruding during an attempt.

(Step S204)

The associated information collecting unit 103 investigates information in the terminal into where the attack execution unit 101 intruded and collects information based on a result of an investigation.

(Step S205)

The degree of attack progression calculation unit 104 calculates the degree of attack progression based on information that the attack result collecting unit 102 has collected so far, and a calculation formula that is set beforehand.

(Step S206)

The degree of goal achievement calculation unit 105 calculates the degree of goal achievement based on the information that the associated information collecting unit 103 has collected so far and the calculation formula that is set beforehand.

(Step S207)

The attack route change determination unit 106 determines whether or not to continue the attack on the network segment of the terminal into where the attack execution unit 101 is currently intruding based on a score value of the degree of goal achievement that is calculated.

In a case where the attack on the network segment is to continue, the attack status evaluation apparatus 100 proceeds to step S208. In other cases, the attack status evaluation apparatus 100 proceeds to step S210.

The attack route change determination unit 106 may present the degree of goal achievement to the penetration tester, and the penetration tester may determine whether or not to continue the attack instead of the attack route change determination unit 106.

(Step S208)

The attack execution unit 101 executes an aim. As a specific example, in a case where a goal of the attack is “taking over confidential information”, the attack execution unit 101 executes escalation of the privilege, stealing of the authentication information, or the like.

(Step S209)

The attack execution unit 101 verifies whether or not the aim has been successfully executed.

In a case where the attack execution unit 101 has successfully executed the aim, the attack status evaluation apparatus 100 ends the process of the present flowchart, that is, the attack status evaluation apparatus 100 ends the cyberattack. In a case where the attack execution unit 101 failed in the execution of the aim, the attack status evaluation apparatus 100 returns to step S201.

(Step S210)

The attack route change determination unit 106 changes a route of the attack. Hereafter, the attack execution unit 101 attempts an intrusion into a terminal of a different network segment.

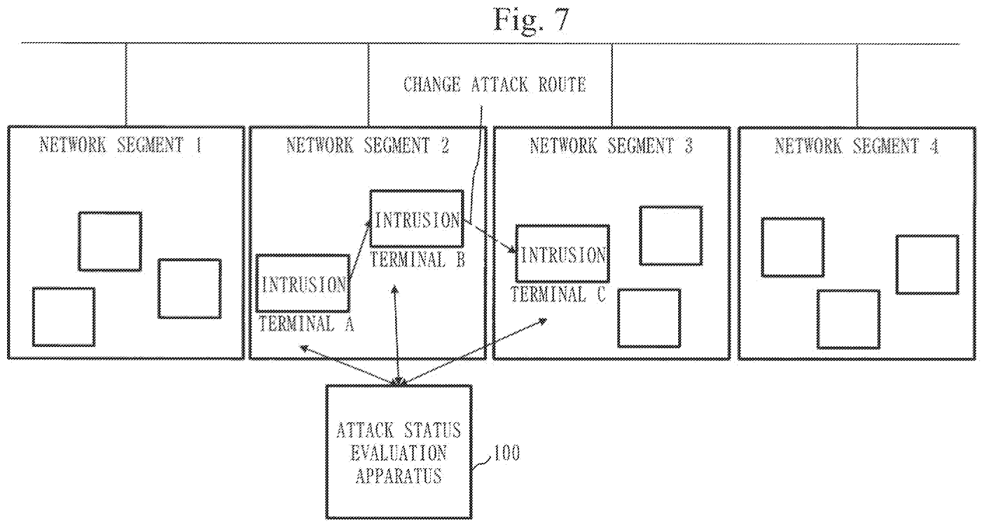

FIG. 7 illustrates a specific example of an attack route change. As illustrated in FIG. 7, after the attack execution unit 101 carries out lateral movement from terminal A to terminal B, the attack execution unit 101 attempts an intrusion into terminal C that is a terminal within a different network segment in a case where the attack route change determination unit 106 determined a change of an attack route. At this time, the attack status evaluation apparatus 100 may operate by performing communication with the terminal into where the attack execution unit 101 intruded, or without having the hardware configuration and being configured only of a program, may operate using a resource of the terminal into where the attack execution unit 101 intruded.

### Description of Effect of Embodiment 1

As described above, the attack status evaluation apparatus 100 according to the present embodiment includes the degree of attack progression calculation unit 104 that scores a degree of progression of the cyberattack according to the calculation formula that is set, the degree of goal achievement calculation unit 105 that scores the degree of goal achievement of the cyberattack according to the calculation formula that is set, and the attack route change determination unit 106 that modifies the attack route in a way to increase the degree of goal achievement. Consequently, the attack status evaluation apparatus 100 can select an attack route that will bring the attack status evaluation apparatus 100 closer to the goal.

According to the present embodiment, the asset information that the penetration tester who is skilled refers to can be taken into consideration, and an attack that conforms more to an actual cyberattack can be automatically performed.

***Other Configurations***

### <Variation 1.>

The attack status evaluation apparatus 100 may, instead of modifying the attack route based on the degree of goal achievement in a way that will bring the attack status evaluation apparatus 100 closer to the goal of the attack, modify the attack route when the score value of the degree of attack progression exceeds a threshold. As a specific example, set 90, 180, 270, . . . as the threshold of the score value of the degree of attack progression. In a case where a speed at which the score value of the degree of goal achievement increases after the degree of attack progression exceeds 90, a first threshold, does not reach a certain value, the attack route change determination unit 106 executes lateral movement to a terminal of a different network segment. In a case where a speed at which the score value of the degree of goal achievement increases after the degree of attack progression exceeds 180, a next threshold, does not reach a certain value, the attack route change determination unit 106 executes lateral movement to a terminal of a different network segment. That is, the attack route change determination unit 106 may change the attack route in a case where the degree of attack progression is more than or equal to a degree of progression threshold and an amount of change of the degree of goal achievement in past unit time is less than an amount of change threshold.

The attack route change determination unit 106 may algorithmically execute a modification of the attack route as indicated in the present variation.

<Variation 2.>

The attack execution unit 101 may execute the intrusion into a plurality of terminals in parallel.

<Variation 3.>

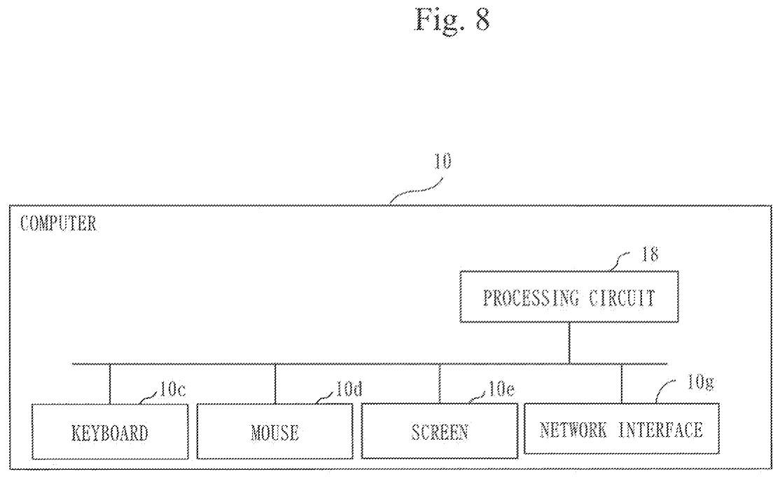

FIG. 8 illustrates an example of a hardware configuration of an attack status evaluation apparatus 100 according to the present variation.

The attack status evaluation apparatus 100 includes a processing circuit 18 instead of the processor 10a, the processor 10a and the main storage device 10b, the processor 10a and the auxiliary storage device 10f, or the processor 10a, the main storage device 10b, and the auxiliary storage device 10f.

The processing circuit 18 is hardware that enables at least a part of each unit that the attack status evaluation apparatus 100 includes.

The processing circuit 18 may be dedicated hardware and may be a processor that executes a program stored in the main storage device 10b.

In a case where the processing circuit 18 is dedicated hardware, the processing circuit 18, as a specific example, is a single circuit, a composite circuit, a programmed processor, a parallel programmed processor, an ASIC (Application Specific Integrated Circuit), an FPGA (Field Programmable Gate Array), or a combination of these.

The attack status evaluation apparatus 100 may include a plurality of processing circuits that replace the processing circuit 18. The plurality of processing circuits share roles of the processing circuit 18.

In the attack status evaluation apparatus 100, a part of functions may be enabled by dedicated hardware and the rest of the functions may be enabled by software or firmware.

The processing circuit 18, as a specific example, is enabled by hardware, software, firmware, or a combination of these.

The processor 10a, the main storage device 10b, the auxiliary storage device 10f, and the processing circuit 18 are generically called “processing circuitry”. In other words, functions of each functional element of the attack status evaluation apparatus 100 are enabled by the processing circuitry.

The computer 20 may also be in a same configuration as the configuration in the present variation.

### Other Embodiments

A description with regard to Embodiment 1 has been given, but within the present embodiment, a plurality of parts may be combined and executed. Or, the present embodiment may be executed partially. In addition, various changes may be made to the present embodiment as necessary, and the present embodiment may be arranged and executed in any manner, either fully or partially.

The embodiment mentioned above is an essentially preferred example, and is not intended to limit the present disclosure, the application of the present disclosure, and the scope of use. The procedures described using the flowchart and the like may be suitably changed.

### REFERENCE SIGNS LIST

10: computer; 10a: processor; 10b: main storage device: 10c: keyboard; 10d: mouse; 10e: screen; 10f: auxiliary storage device; 10g: network interface: 18; processing circuit; 20: computer; 20a: memory; 20b: CPU; 20c: main storage device: 20g: auxiliary storage device; 10: attack status evaluation apparatus; 101: attack execution unit; 102: attack result collecting unit; 103: associated information collecting unit; 104: degree of attack progression calculation unit; 105: degree of goal achievement calculation unit, 106: attack route change determination unit; 107: attack goal DB: 108: associated information DB: 109: attack outcome DB; 110: vulnerability score DB; 111: degree of attack progression score DB; 112: degree of goal achievement score DB; 113: attack goal information; 114: vulnerability score information.

1. An attack status evaluation apparatus that emulates a cyberattack that steals information, the attack status evaluation apparatus comprising:
processing circuitry to:
calculate a degree of goal achievement that indicates a degree to which a goal is achieved in the cyberattack based on information that the attack status evaluation apparatus stole, and
determine whether or not to change an attack route of the cyberattack according to the degree of goal achievement.

2. The attack status evaluation apparatus according to claim 1, wherein
the processing circuitry calculates the degree of goal achievement based on associated information that is the information that the attack status evaluation apparatus stole and that is information associated with achieving the goal.

3. The attack status evaluation apparatus according to claim 2, wherein
the associated information includes information that indicates an access right, and
the processing circuitry calculates the degree of goal achievement according to a type of access right that the associated information includes.

4. The attack status evaluation apparatus according to claim 1, wherein
the processing circuitry
calculates a degree of attack progression that indicates a progression situation of the cyberattack based on vulnerability information that indicates a vulnerability in a target of the cyberattack, and
determines whether or not to change the attack route of the cyberattack according to the degree of attack progression.

5. The attack status evaluation apparatus according to claim 2, wherein
the processing circuitry
calculates a degree of attack progression that indicates a progression situation of the cyberattack based on vulnerability information that indicates a vulnerability in a target of the cyberattack, and
determines whether or not to change the attack route of the cyberattack according to the degree of attack progression.

6. The attack status evaluation apparatus according to claim 3, wherein
the processing circuitry
calculates a degree of attack progression that indicates a progression situation of the cyberattack based on vulnerability information that indicates a vulnerability in a target of the cyberattack, and
determines whether or not to change the attack route of the cyberattack according to the degree of attack progression.

7. The attack status evaluation apparatus according to claim 4, wherein
the processing circuitry calculates the degree of attack progression based on attack outcome information that is information that the attack status evaluation apparatus stole and that is information equivalent to an outcome of the cyberattack.

8. The attack status evaluation apparatus according to claim 5, wherein
the processing circuitry calculates the degree of attack progression based on attack outcome information that is information that the attack status evaluation apparatus stole and that is information equivalent to an outcome of the cyberattack.

9. The attack status evaluation apparatus according to claim 6, wherein
the processing circuitry calculates the degree of attack progression based on attack outcome information that is information that the attack status evaluation apparatus stole and that is information equivalent to an outcome of the cyberattack.

10. The attack status evaluation apparatus according to claim 7, wherein
the processing circuitry changes the attack route in a case where the degree of attack progression is more than or equal to a degree of progression threshold and an amount of change of the degree of goal achievement in past unit time is less than an amount of change threshold.

11. The attack status evaluation apparatus according to claim 8, wherein
the processing circuitry changes the attack route in a case where the degree of attack progression is more than or equal to a degree of progression threshold and an amount of change of the degree of goal achievement in past unit time is less than an amount of change threshold.

12. The attack status evaluation apparatus according to claim 9, wherein
the processing circuitry changes the attack route in a case where the degree of attack progression is more than or equal to a degree of progression threshold and an amount of change of the degree of goal achievement in past unit time is less than an amount of change threshold.

13. An attack status evaluation method that an attack status evaluation apparatus that emulates a cyberattack that steals information executes, the attack status evaluation method comprising:
calculating a degree of goal achievement that indicates a degree to which a goal is achieved in the cyberattack based on information that the attack status evaluation apparatus stole; and
determining whether or not to change an attack route of the cyberattack according to the degree of goal achievement.

14. A non-transitory computer readable medium storing an attack status evaluation program that an attack status evaluation apparatus, a computer that emulates a cyberattack that steals information, executes, the attack status evaluation program that causes the attack status evaluation apparatus to execute:
a degree of goal achievement calculation process to calculate a degree of goal achievement that indicates a degree to which a goal is achieved in the cyberattack based on information that the attack status evaluation apparatus stole; and
an attack route change determination process to determine whether or not to change an attack route of the cyberattack according to the degree of goal achievement.
